(19) United States
(12) Patent Application Publication
(10) Pub. No.: US 2008/0305371 A1
(43) Pub. Date: Dec. 11, 2008

(54) System and method for carbon neutral or carbon positive production and use of hydrogen gas

(76) Inventors: William Hermann, Sealy, TX (US); Bass Blundell, Richmond, TX (US)

Correspondence Address: STRASBURGER & PRICE, LLP, 901 MAIN STREET, SUITE 4400, DALLAS, TX, 75202, US

(21) Appl. No.: 12/156,569

(22) Filed: Jun. 3, 2008

Related U.S. Application Data
(60) Provisional application No. 60/933,094, filed on Jun. 4, 2007.
(60) Provisional application No. 61/008,894, filed on Dec. 21, 2007.

(51) Int. Cl. H01M 8/04; C10J 1/20

(52) U.S. Cl. 429/17; 48/199 R

(57) ABSTRACT

A system and method for the production and use of hydrogen to obtain sufficient energy to negate or obtain a positive carbon unit balance. Waste is converted into a synthesis gas and heat energy using a plasma converter. The heat energy is transformed into electrical energy. The synthesis gas is split into hydrogen and carbon monoxide. Both the hydrogen and carbon monoxide may be used for the production of electricity. If desired some hydrogen may be used to fuel vehicles.

### CROSS REFERENCE TO RELATED APPLICATIONS

This application claims the benefit of Provisional U.S. Patent Application No. 60/933,094 filed Jun. 4, 2007 and Provisional U.S. Patent Application No. 61/008,894 filed Dec. 21, 2007.

### STATEMENT REGARDING FEDERALLY FUNDED RESEARCH AND DEVELOPMENT

The invention described in this patent application was not the subject of federally sponsored research or development.

### FIELD

The present invention pertains to a system and method for the reliable production and use of hydrogen gas from either hydrocarbon waste from a refinery (often called pet coke) or from the waste obtained from a water treatment plant; more particularly, the disclosed system and method relates to the reliable production and use of hydrogen gas where the net carbon unit balance from the disclosed system and method is neutral or positive.

### BACKGROUND

Hydrogen gas is a fuel which has the highest energy content per unit weight of any known fuel. In addition, hydrogen gas burns cleanly. When hydrogen gas is burned together with oxygen the only byproducts of the combustion are heat and water. Because of its value as a fuel, hydrogen gas is a commodity which is demanded in increasing quantities by businesses needing significant amounts of energy for their operation. Unfortunately, many of the processes for the production of hydrogen gas needed by businesses with high energy requirements also emit both carbon monoxide gas and carbon dioxide gas.

The emission of carbon monoxide gas into the atmosphere and carbon dioxide gas has been strictly controlled by those state and federal regulatory agencies concerned about air quality. One method of effecting this control is by use of an accounting or measurement system wherein those businesses expecting to release carbon monoxide gas and carbon dioxide gas into the atmosphere must purchase a license from a government agency before making such emissions. The cost of the emission license is based on the number of carbon units which the business expects to release into the atmosphere multiplied by a predetermined rate per carbon unit.

In certain circumstances the number of carbon units associated with a license to release carbon monoxide or carbon dioxide into the atmosphere can be reduced by obtaining positive carbon credits. Such positive carbon credits can be obtained by various methods such as returning energy to an energy distribution system; for example, returning electrical energy to an electrical energy distribution grid. Accordingly, many businesses have adopted the goal of becoming either carbon unit neutral or carbon unit positive by contributing as much as or more energy than used for their operation to an energy distribution system. The purpose of becoming carbon unit neutral or carbon unit positive is to avoid the cost of a license to release predetermined amount of carbon monoxide gas or carbon dioxide gas into the atmosphere.

U.S. Pat. No. 4,181,100 teaches that an increase in the efficiency of and a reduction in the emissions from an internal combustion engine may be obtained by injecting hydrogen gas into the in the air intake of the internal combustion engine. The U.S. Jet Propulsion Labs and other testing agencies that have studied the injection of hydrogen gas into the air intake of an internal combustion engines and verified the teachings of U.S. Pat. No. 4,181,100.

Another major concern about energy sources is reliability. While alternative energy sources such as solar power and wind energy have garnered much attention, both solar power panels and wind power generators depend on favorable weather conditions. Accordingly, a need remains for a reliable source of energy which is not dependent on something as variable as weather.

There is therefore a need in the art for a system and method for the reliable production and use of hydrogen made from either hydrocarbon waste or waste from an aqueous water treatment plant wherein the system and method operates to be either carbon neutral or carbon positive. Such hydrogen gas can be used for fuel, the generation of electricity, and to increase the efficiency of and reduce the emissions of power plants used in vehicles.

### SUMMARY

The system and method of the present invention for the reliable production and use of hydrogen gas obtained from either hydrocarbon waste or the waste generated by water treatment plant operates to be either carbon unit neutral or carbon unit positive. The generated hydrogen may be used for fuel, the generation of electricity and/or increasing the efficiency of and reducing the emissions from power plants used in vehicles.

According to the preferred embodiment of the disclosed system and method a synthesis gas along with heat energy are produced when the hydrocarbon waste materials from a refinery or waste materials from a water treatment plant are processed through a plasma converter. The heat energy produced along with the synthesis gas is used to power a turbine for the production of electricity. If desired, only as much synthesis gas and heat energy are produced by the disclosed system and method to enable it to be considered carbon neutral or carbon positive.

According to the present invention, the first step in the disclosed process is processing waste material through a plasma converter to create a synthesis gas, composed primarily of hydrogen gas and carbon monoxide gas, and heat energy. Predetermined amounts of the synthesis gas are sent to a hydrogen extraction plant. Heat energy developed by the hydrogen plant may be used for the production of electricity. The electricity will be produced in sufficient quantities to reduce or eliminate the cost of obtaining carbon credits.

Remaining or additional hydrogen may be made available for use in vehicles powered by fuel cells or by internal combustion engines.

### BRIEF DESCRIPTION OF THE DRAWING FIGURES

A still better understanding of the system and method of the present invention may be had by the drawing figures wherein:

FIG. 1 is a flow diagram of a preferred of the system and method of the present invention;

FIG. 2 is a flow diagram of a first alternate embodiment of the disclosed system and method; and

FIG. 3 is a flow diagram of a second alternate embodiment of the disclosed system and method.

### DESCRIPTION OF THE EMBODIMENTS

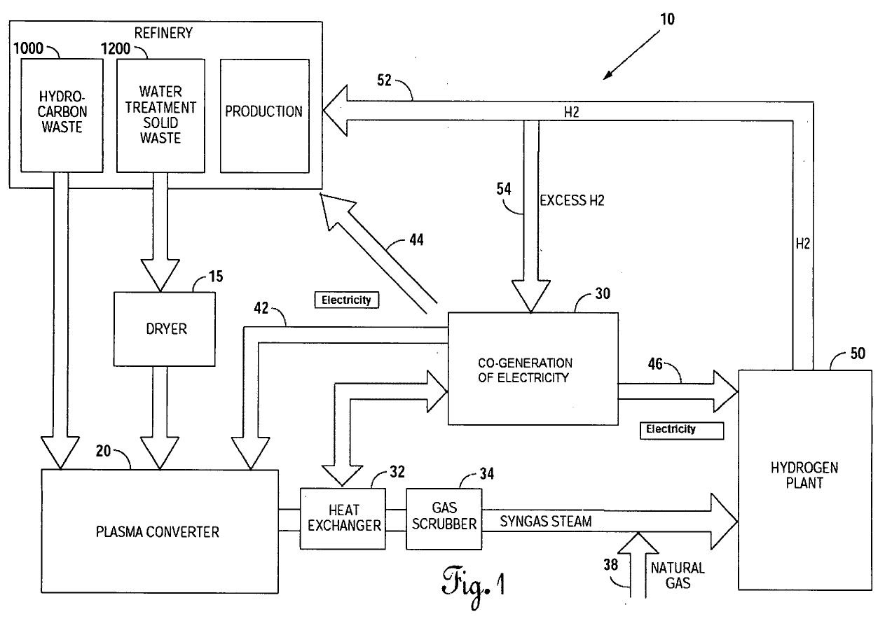

By reference to FIG. 1 and the following description thereof, those of ordinary skill in the art will understand the preferred embodiment of the system and method of the present invention 10.

First, the hydrocarbon waste 1000 from a refinery or the waste 1200 from a water treatment plant is processed through a plasma converter 20. A dryer 15 may be used for the waste 1200. The output from the plasma converter 20 is a synthesis gas, which is a mixture of primarily hydrogen gas and carbon monoxide gas, along with heat energy.

The flow of synthesis gas and heat energy through a heat exchanger 32 and a gas scrubber 34 is fed to a large hydrogen extraction plant 50. The heat energy with the synthesis as is used to power a heat driven turbine 30 for the generation of electricity. Downstream from the gas scrubber 34 is located the hydrogen extraction plant 50 where the hydrogen is separated out of the synthesis gas. To aid in the separation of the hydrogen from the synthesis gas, the synthesis gas may be mixed with a flow of natural gas 38.

Heat from the heat exchanger 32 is used to turn a turbine for the production of electricity. The generated electricity from the turbine 30 may be directed back 42 to the operation of the plasma converter 20, directed 44 to the refinery producing the hydrocarbon waste, the water treatment plant producing waste from water treatment and/or directed 46 to the hydrogen extraction plant 50. The hydrogen output from the hydrogen extraction plant 50 may be used as a fuel 52 in the refinery or in the water treatment plant. Any excess hydrogen may be directed 54 to the turbines 30 for the generation of electricity.

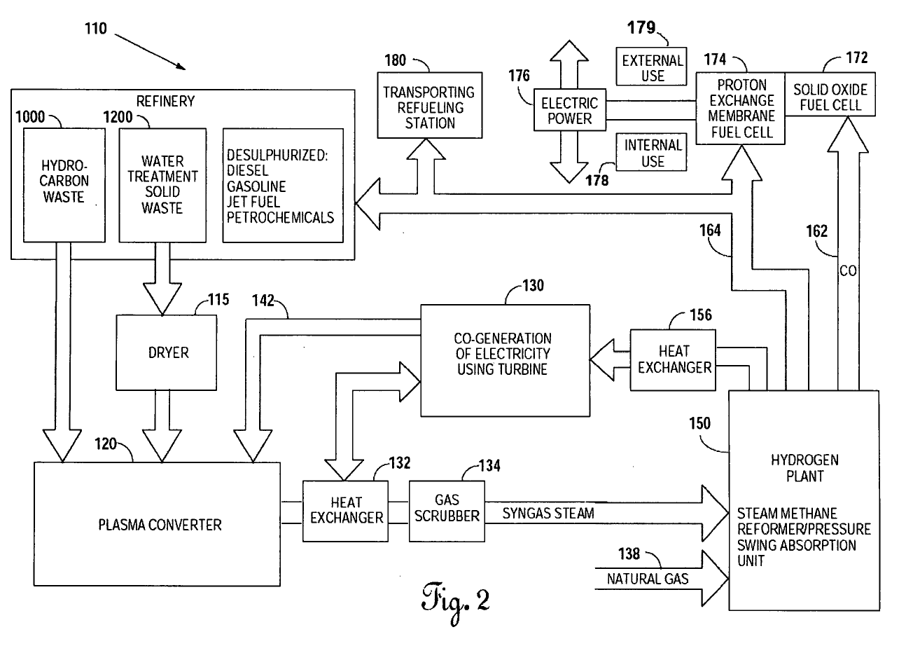

Shown in FIG. 2 is a system 110 similar to that shown in FIG. 1 however the carbon monoxide 162 and hydrogen 64 produced may also separately be used for the generation of energy as discussed below. Beginning with the either the hydrocarbon waste material 100 or the waste material 1200 from a water treatment plant as a starting material, as shown in FIG. 1, the waste 1200 from the water treatment plant is run through an optional dryer 115 before entering the plasma converter 120. The synthesis gas output from the plasma converter 120 passes through a heat exchanger 132 where some of the available heat energy is used for the generation of electricity using heat driven turbines 130. The remaining synthesis gas leaves the heat exchanger 132 and passes through a gas scrubber 134 on its way to the hydrogen extraction plant 150. As shown in FIG. 1, a natural gas flow 138 may be used to augment the flow of the synthesis gas. The outflow from the hydrogen extraction steam methane reformer/pressure swing absorption unit 150 may pass through a heat exchanger 156 where the heat energy obtained therefrom may be sent to the electricity generating turbines 130 previously discussed.

The carbon monoxide gas 162 from the hydrogen extraction plant 150 is sent to a solid oxide fuel cell 172. The hydrogen 164 from the hydrogen extract plant 150 is sent to a proton exchange membrane fuel cell 174. The energy output from the solid oxide fuel cell 172 and the proton exchange membrane fuel cell 174 is electrical energy 176. The produced electrical energy may be used within 178 the disclosed system or passed onto 179 a user outside of the system. Further, it is also possible to transport hydrogen gas from the system to a station where the hydrogen may be made available for use in vehicles 180. Such vehicles may be those using fuel cells designed to run on hydrogen energy or those vehicles using internal combustion engines. Those vehicles having internal combustion engines will include a tank for containing the pressurized hydrogen. During the operation of the internal combustion, the hydrogen from the tank will be included with the air flow into the carburetor or fuel injectors providing gasoline or diesel fuel into the combustion chambers as described in U.S. Pat. No. 4,181,100.

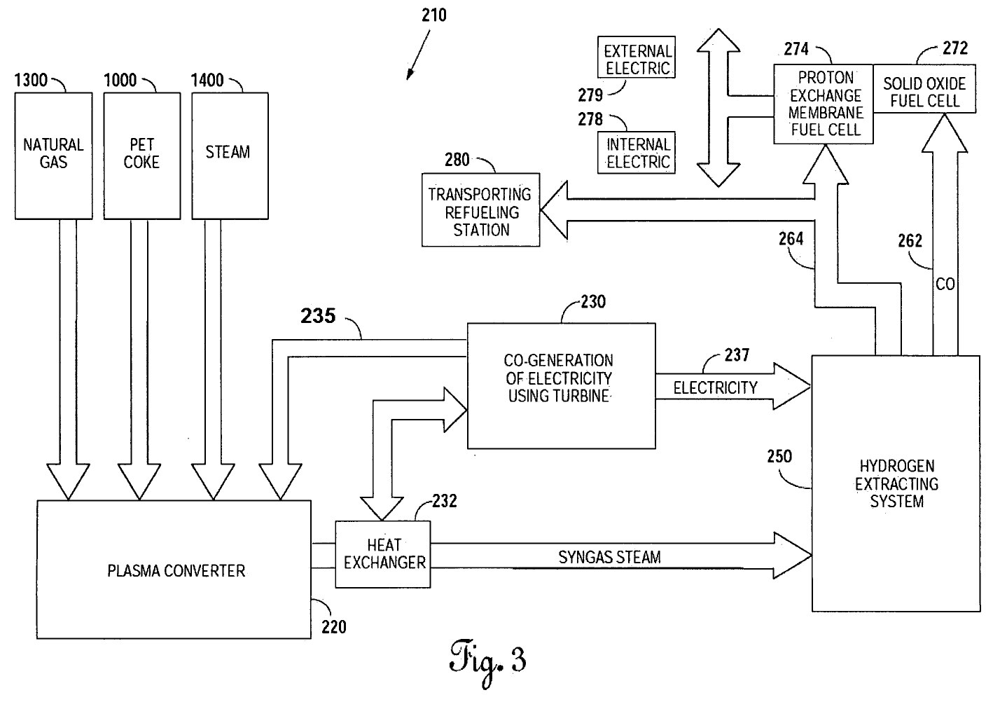

Shown in FIG. 3 is a second alternate embodiment 210 of the disclosed invention. The starting material provided to the plasma converter includes hydrocarbon waste or pet coke 1000 as previously described. This flow of starting material may be supplemented by natural gas 1300 and/or a flow of steam 1400. Outflow from the plasma converter 220 is synthesis gas and heat energy. The synthesis gas and heat energy is caused to pass through a heat exchanger 232 where the extracted heat energy is conducted to a turbine electricity generating plant 230. The electricity from the electricity generating plant 230 is used to provide 235 power for the plasma converter 220 and provide 237 power for the hydrogen extraction plant 250. As shown in FIG. 2, the carbon monoxide gas from the hydrogen extraction plant flows 262 to a solid oxide fuel cell 272 for the production of electricity. The hydrogen flows 264 to a proton exchange membrane fuel cell 274 for the production of electricity. As shown in FIG. 2, the electricity may be used within 278 the system or provided to users outside 279 the system. Remaining hydrogen may be provided to vehicles 280 as previously described.

A further understanding of the disclosed invention may be had by its use in one or more of the described exemplary models: a) Refinery/Residential Model, b) the Central Power Plant Model, and c) the Storage Tank Model.

Refinery/Residential Model

The excess hydrogen production of an oil/gas refinery produced by the steam reformer unit of a refinery is transported to a residential subdivision. The homes in the residential subdivision will be both all electric and built for low or zero emissions. Also included with the total energy system model for the homes in the residential subdivision will be a fuel cell powered or hydrogen augmented internal combustion powered vehicle which has been financially capitalized with the home as the home and the vehicle are sold together as a package. The excess hydrogen from the refinery will be off-loaded to a vehicle re-fueling station located in the subdivision. Waste from the houses in the subdivision will be collected and sent back to the plasma converter located at the refinery to produce additional synthesis gas.

Residential Central Power Plant Model

At the oil/gas refinery the excess hydrogen is transferred into a gas transport truck which will transport the compressed hydrogen gas to a subdivision as described above in the Refinery/Residential Model. The transported hydrogen gas will then be collected at a central plant located in the subdivision. At this central plant the hydrogen will be processed through a sufficient number of fuel cells to provide electrical power for all of the homes in the entire subdivision. This production of electrical power from fuel cells is a zero emissions process. Accordingly, the electrical power usage will be relatively constant and can be then set at a fixed price for the residents of the subdivision. Such fixed price will be lower than current rates for commercially available electrical power because of a long term hydrogen purchasing agreement between the oil/gas refinery and the residential subdivision.

Storage Tank Model

As with the Refinery/Residential Model and the Residential Central Power Plant Model, hydrogen from the refinery is transported by trucks to a residential subdivision. At the residential subdivision the hydrogen is further distributed by truck to a storage tank at each house and then stored much like the typical storage system for propane gas in use. From each residential storage tank, the hydrogen will be consumed by a fuel cell energy station at each residence to generate electricity. Each house will be supplied with enough hydrogen to enable meeting several days' demand for electricity without needing a hydrogen gas re-fill. An electrical grid will be formed connecting the homes in the subdivision to provide electrical power for use in common areas as well as use for providing back-up electrical power when a fuel cell at a residence has gone off-line, is undergoing repair, or is undergoing scheduled maintenance.

According to the described exemplary models, the following economic benefits will be provided:

For the Home Owners in the Subdivision:

Long term fixed electric power costs

Long term fixed or reduced operating costs

Local electrical grid will have sufficient available electrical power capacity to overcome fuel cell outages

Trash, to include hazardous waste, can be picked up at no charge to the homeowner as hazardous waste is used to create the synthesis gas which is used to produce electrical power

For the Builder of the Homes in the Subdivision

Core business of selling homes is strengthened through providing economic advantages to homeowners with unique and exclusive energy benefits

For the Makers of Equipment Used in the Homes in the Subdivision

Opportunity to sell specialized products in a higher volume context of benefiting both daily life and community development.

For the Energy Providers to the Homes in the Subdivision

Opportunity to purchase hydrogen gas at below market price

Hydrocarbon waste/hazardous waste/aqueous waste is handled on site for no cost

Positive reputation is established for providing hydrogen gas to both subdivision homes and to vehicles associated with the homes at discounted prices

Carbon credits obtained are sufficient to offset the carbon units from both waste disposal carbon production and hydrogen creation carbon production.

While the disclosed invention has been described according to its preferred and alternate embodiments, those of ordinary skill in the art will understand that numerous other embodiments have been enabled. Such other embodiments shall be included in the scope and meaning of the appended claims.

What is claimed is:

1. A neutral or positive carbon unit balance method of producing and using hydrogen gas from a refinery produced hydrocarbon waste and/or water treatment produced waste, said method comprising the steps of:
processing the hydrocarbon waste and/or the aqueous water treatment waste through a plasma converter to produce a synthesis gas and heat energy, said synthesis gas being composed primarily of hydrogen and carbon monoxide gas;
feeding a predetermined amount of said synthesis gas and heat energy to a heat exchanger for use in the production of electrical power to yield a predetermined number of carbon units;
feeding a predetermined amount of said synthesis gas to a hydrogen extracting system;

2. The method of claim 1 wherein the flow of said synthesis gas into said hydrogen extraction system includes added natural gas.

3. The method of claim 1 wherein said electrical power is produced by a heat driven turbine.

4. The method of claim 1 wherein said electrical power is provided to one or both of the plasma converter and the hydrogen extraction unit.

5. The method of claim 1 wherein the hydrogen from said hydrogen extraction unit is used to provide electrical power

6. A neutral or positive carbon unit balance method of producing and using hydrogen gas produced from refinery waste and/or water treatment waste, said method comprising the steps of:
processing the refinery waste and/or water treatment waste through a plasma converter to produce a synthesis gas, said synthesis gas being composed primarily of hydrogen gas and carbon monoxide gas;
feeding a first predetermined amount of said synthesis gas to a heat exchanger to obtain heat energy;
using said heat energy for the production of a sufficient amount of electricity to obtain a predetermined number of carbon units;
feeding a second predetermined amount of said synthesis gas to a hydrogen extraction system;
using the hydrogen from said hydrogen extraction system to provide hydrogen gas for operating the refinery and/or waste water treatment and to produce electrical energy using a fuel cell;
using the carbon monoxide produced by said hydrogen extraction system to produce electricity using a fuel cell.

7. The method as defined in claim 6 wherein said second predetermined amount of said synthesis gas is supplemented with natural gas.

8. The method as defined in claim 6 wherein the heat from said first predetermined amount of said synthesis gas is conducted to a turbine for the production of electricity;

9. The method as defined in claim 6 wherein a portion of the hydrogen from said hydrogen extraction unit is provided to vehicles for use in a power plant of the vehicle.

10. The method as defined in claim 6 wherein the hydrogen from said hydrogen extraction plant passes through a proton exchange membrane fuel cell and the carbon monoxide from said hydrogen extraction plant passes through a solid oxide fuel all.

11. A neutral or positive carbon unit balance method of producing and using hydrogen gas produced from refinery waste, said methods comprising the steps of:
processing the refinery waste through a plasma converter to produce a synthesis gas including hydrogen and carbon monoxide;
supplementing the flow of said refinery to said plasma converter with one or both of flows of natural gas and steam;
feeding a first predetermined amount of a synthesis gas to heat exchanger to obtain heat energy;
using said heat energy for the production of a predetermined amount of electrical energy to obtain a predetermined number of carbon units;
feeding a second predetermined amount of said synthesis gas to a hydrogen extraction system;
passing the hydrogen from said hydrogen extraction system through a fuel cell to obtain electrical energy; and
passing the carbon monoxide from said hydrogen extraction system through a fuel cell to obtain electrical energy;

12. The method as defined in claim 8 wherein the heat from said first predetermined amount of said synthesis gas is conducted to a turbine for the production of electricity

13. The method as defined in claim 8 wherein the hydrogen from said hydrogen extraction plant is provided to vehicular power plants.

14. The method as defined in claim 12 wherein the electricity from said turbine electrical energy plant is directed to said plasma converter and to said hydrogen extraction unit.

15. The method as defined in claim 11 further including the step of passing the carbon monoxide from said hydrogen extraction plant through a solid oxide fuel cell for the production of electricity

16. The method as defined in claim 11 further including the step of passing the hydrogen from said hydrogen extraction plant through a proton exchange membrane fuel cell for the production of electricity.

17. The method as defined in claim 1, claim 5 or claim 10 further including the step of directing electrical power to a residential subdivision and hydrogen from said hydrogen extraction plant to a vehicle re-fueling station located within said subdivision.

18. The method as defined in claim 1, claim 5 or claim 10 further including the step of directing hydrogen gas from said hydrogen extraction plant to a central power plant for the production of electrical energy to meet the electrical energy demands of a residential subdivision.

19. The method as defined in claim 1, claim 5 or claim 10 further including the step of directing hydrogen gas to a storage tank associated with each home in a residential subdivision for the production of electrical energy using a fuel cell located at each home in a subdivision.

20. The method as defined in claim 19 further including the step of correcting the homes in said subdivision to a grid whereby electrical energy may be provided when a fuel cell at one individual home is out of service.
